(19) United States
(12) Patent Application Publication
(10) Pub. No.: US 2020/0159560 A1
(43) Pub. Date: May 21, 2020

(54) PROPAGATING ORDERED OBJECT CHANGES

(71) Applicant: Avi Networks, Santa Clara, CA (US)

(72) Inventors: Douglas Safreno, San Francisco, CA (US); Phillip Jones, San Francisco, CA (US); Vivek Kalyanaraman, Milpitas, CA (US)

(21) Appl. No.: 16/432,764

(22) Filed: Jun. 5, 2019

Related U.S. Application Data
(60) Provisional application No. 62/768,654, filed on Nov. 16, 2018.

(51) Int. Cl. G06F 9/455; G06F 9/445; G06F 8/71; G06F 9/54

(52) U.S. Cl. CPC G06F 9/45558; G06F 9/44505; G06F 8/71; G06F 2009/45575; G06F 2009/4557; G06F 2009/45583; G06F 2009/45591; G06F 9/547

(57) ABSTRACT

In an embodiment, a method for propagating ordered object changes includes synchronizing a client's version of configured objects with a configuration server's version of configured objects, including obtaining a list of object identifiers and a first version identifier of an object from the server. The method includes recursively getting objects at a version identified by the first version identifier from the server to construct an object graph on the client. The method includes subscribing to a configuration stream associated with the server (including sending the first version identifier) and obtaining responses from the configuration server where a response includes a second version identifier and a corresponding object identifier for an object that has been reconfigured between the first version and the second version. The method includes getting an updated version of the objects identified in the stream by the second version identifier to update the object graph.

### CROSS REFERENCE TO OTHER APPLICATIONS

This application claims priority to U.S. Provisional Patent Application No. 62/768,654 entitled PROPAGATING ORDERED OBJECT CHANGES filed Nov. 16, 2018 which is incorporated herein by reference for all purposes.

### BACKGROUND OF THE INVENTION

An application delivery platform can deliver services such as load balancing, application analytics, and security features. The application delivery platform can have a variety of components and devices such as servers, virtual machines, and health monitors. In some situations, clients interacting with the application delivery platform can easily synchronize to the latest state by obtaining the data from the server and delivering the data to a user. For example, a social networking app running on a mobile phone can fetch the current set of posts that friends have made, and then display them for the user. However, in some situations fetching and pushing changes is challenging. For example, the data may be configuration information (such as changes to the configuration of objects in the application delivery platform), which determines how networking logic routes traffic. In conventional systems, typically a client can only handle one new piece of data at a time in the exact order that the system administrator made the change. A conventional server typically collects changes and stores them in a set of changes before pushing them to the client. Thus, propagating object changes is often computationally expensive and inefficient.

### BRIEF DESCRIPTION OF THE DRAWINGS

Various embodiments of the invention are disclosed in the following detailed description and the accompanying drawings.

FIG. 1 is a block diagram illustrating an embodiment of an application delivery platform for delivering application services.

FIG. 2 is a block diagram illustrating an embodiment of a system for propagating ordered object changes.

FIG. 3 shows an example of a process to propagate ordered object changes.

FIG. 4A illustrates an example of a first version of an object graph.

FIG. 4B illustrates an example of a version of an object graph after a pool has been renamed.

FIG. 4C illustrates an example of a version of an object graph after a health monitor has been assigned to a server pool.

FIG. 4D illustrates an example of a version of an object graph after a server pool has been assigned to a virtual service.

FIG. 4E illustrates an example of a version of an object graph after a health monitor has been assigned to a second server pool.

FIG. 4F illustrates an example of a diff queue for propagating ordered changes.

FIG. 4G illustrates an example of a master state for propagating ordered changes.

FIG. 5 is a flow chart illustrating an embodiment of a process performed by a client to propagate ordered object changes.

FIG. 6 is a flow chart illustrating an embodiment of a process performed by a server to propagate ordered object changes.

FIG. 7 is a functional diagram illustrating a programmed computer system for propagating ordered object changes in accordance with some embodiments.

FIG. 8 is a block diagram illustrating an embodiment of a distributed network service platform.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

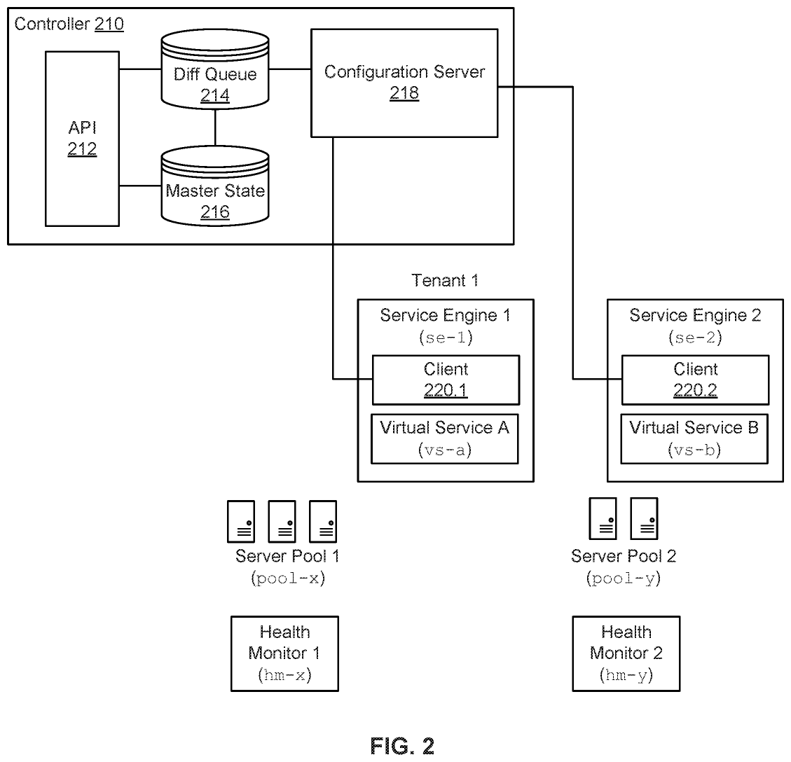

Techniques for propagating ordered object changes are disclosed. The techniques described here are more efficient and require fewer computational resources (memory and processing cycles) than a conventional system. A controller can be configured to stream arbitrary configuration changes to clients (a client is a process running on a service engine for example as further described with respect to FIG. 2). Changes can be “played forward,” meaning configuration changes are applied in order to bring the client up to date to a specified (e.g., current) version.

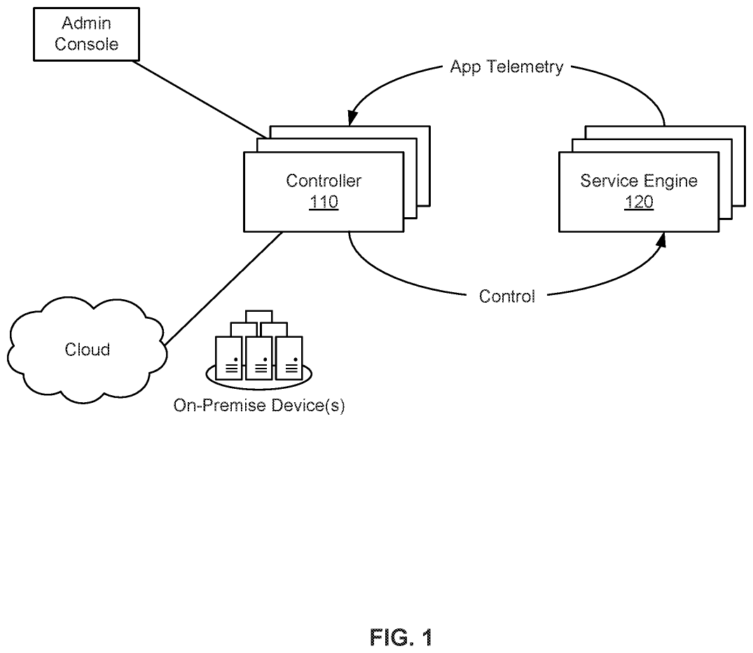

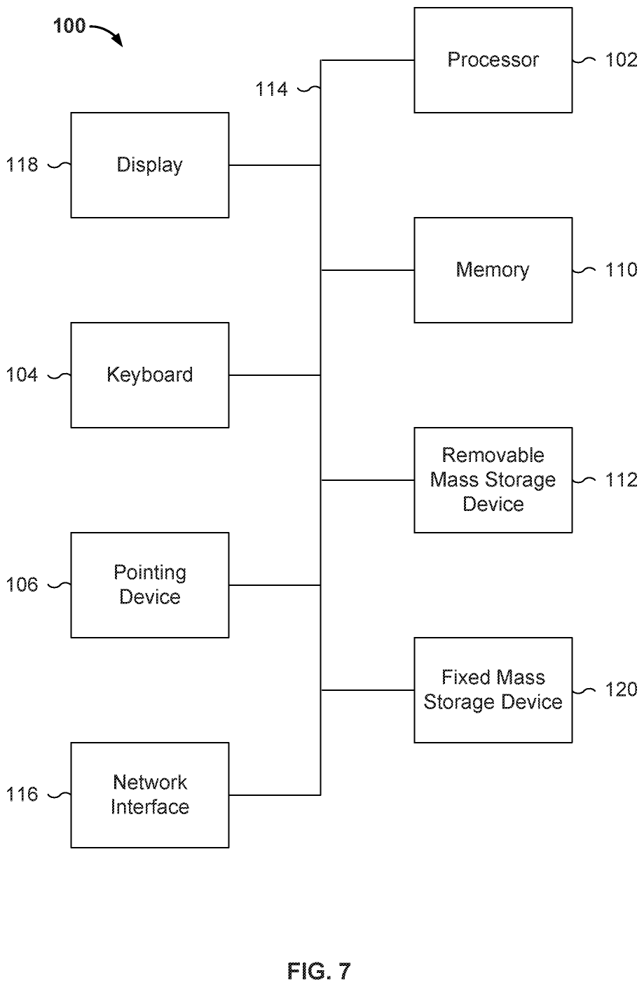

First, an example system in which the techniques may be implemented will be described (FIG. 1). Next, a method for propagating ordered object changes will be described (FIGS. 2-6). Finally, an example programmed system for implementing the techniques is described (FIG. 7).

FIG. 1 is a block diagram illustrating an embodiment of an application delivery platform for delivering application services. An example of application delivery network is Avi Vantage by Avi Networks®. The application delivery platform can deliver services such as load balancing, application analytics, auto-scaling, web application firewalls and other security features, and the like across a variety of infrastructures. For example, the platform provides a dynamic pool of resources on servers (e.g., x86 servers), virtual machines, or containers, which provides scalability while being easy to manage with a central controller. The application services can be delivered on-premises or in cloud environments (including public and private clouds).

The system includes one or more controller modules 110 (collectively called “the controller”) and one or more service engines 120 (collectively called “the service engine”). In this system, a central control plane (the controller) is separated from a distributed data plane (the service engine). The controller provides a single point of management, and can be deployed with redundancy as shown. For example, a three-node cluster means that if one or two controllers fails, the group of controllers can still provide control functions. The single point of management means that the application delivery platform is managed through a centralized point and IP address regardless of the number of new applications being load balanced and the number of service engines required to handle the load. The controller can create and configure new service engines as new applications are configured via virtual services.

The controller is configured to exchange information with each other and with the service engine. For example, the controller requests or receives server health, client connection statistics, and client-request logs collected by service engines. The controller also processes logs and analytics information. The controller sends commands such as configuration changes to the service engines. In various embodiments, the controller and the service engine communicate over their IP addresses. The controller may use specific ports such as TCP ports for network services.

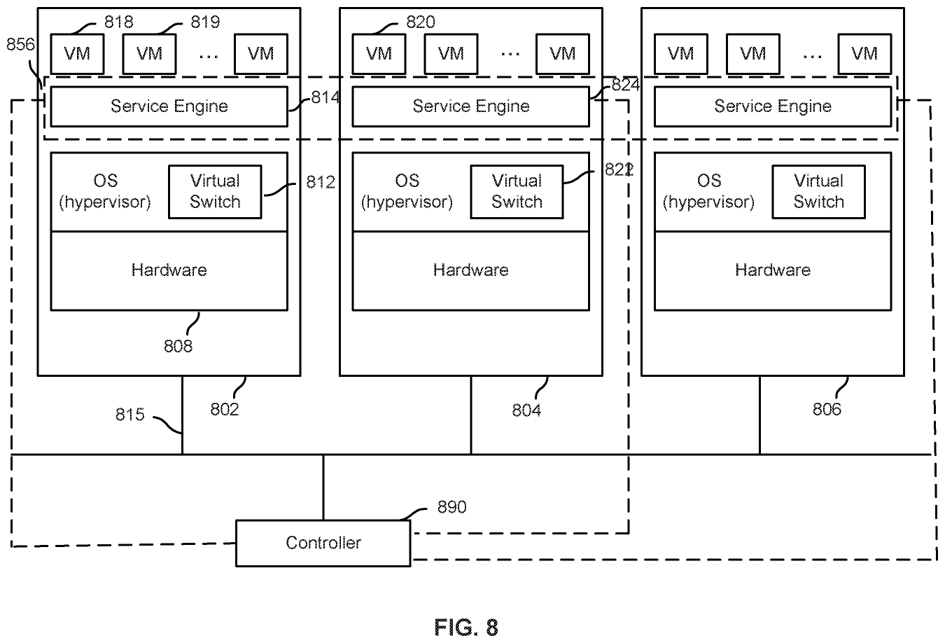

The service engine handles data plane operations by receiving and executing instructions from the controller. For example, the service engine can perform load balancing and other client- and server-facing network interactions, collect real-time application telemetry from traffic flows, and monitor the health of the network. As further described with respect to FIG. 8, in a load balancing scenario, a client communicates with a virtual service, which is configured with an IP address and port hosted in the application delivery platform by a service engine. A request is forwarded internally to a pool, which chooses an available server. A new TCP connection then originates from the service engine, using an IP address of the service engine on the internal network as the request's source IP address. The client then communicates exclusively with the virtual service IP address and not the real server IP address.

Virtual services may be scaled across one or more service engines so that the service engines share the load. The sharing need not be equal depending on available CPU and other resources. A service engine will typically process traffic for more than one virtual service at a time. Each service engine load balances and forwards traffic to servers using its own IP address within the server network as the source IP address of the client connection.

An administrator can interact with the controller via an admin console. The admin console is a web-based user interface that provides (role-based) access to control, manage, and monitor applications. For example, services provided by the platform are available as REST API calls. The administrator can specify configuration changes to objects in the system. The controller and service engine cooperate to propagate the changes in an ordered manner according to the techniques disclosed here.

The configuration of an object determines how networking logic routes traffic, and a configuration change is any change to a property of an application delivery platform component such as a pool, virtual service, and service engine. An application delivery platform can have various objects with properties. An example of an object is a virtual service that has an associated virtual IP address and port for load balancing across a pool of servers as further described with respect to FIG. 8. A configuration change is a change to properties of the virtual service such as the virtual IP address, port, and the composition of servers in its pool. The controller receives the configuration changes from the admin console, and pushes the changes to the service engine. Because of the way the data plane (service engine) is implemented, it typically can only handle certain commands in a certain order.

The service engine is typically implemented in a way that only enables them to handle one new piece of data (configuration change) at a time. Each new piece of data is also expected to be received in a particular order in which the administrator made the change so that some combinations of configuration changes are invalid.

A conventional way to propagate configuration changes is as follows. When an administrator makes a configuration change, the controller constructs a set of changes such as remote procedure calls (RPCs) and pushes the changes to every service engine associated with the controller. The controller constructs the set of changes based on a series of changes that correspond to the desired configuration change. For example, suppose a pool has a health monitor that runs on a service engine. The controller communicates with the health monitor on a specified port. The data plane does not conventionally support changing the port in a single action, e.g., change from port 80 to port 90. Instead, an administrator needs to remove the health monitor, then add the health monitor, and designate the new port (port 90) so the set of changes would correspond to these actions.

In case of a loss of connection where changes cannot be immediately pushed to service engines, the configuration changes are temporarily stored in an in-memory queue in the controller. Constructing the set of changes is computationally expensive, takes up a lot of memory space, and is not easily scalable. In one aspect, the controller constructs the set of changes by comparing new objects with old objects. New objects come through API 212, and the controller creates changes by comparing the new object with the old object. For example, the controller creates a name change if it compares the new and old objects and sees that the name of an object changed from X to Y. Some configuration changes may be lengthy requiring a large set of changes.

The techniques for propagating ordered object changes disclosed here allow streaming of arbitrary configuration changes made on a server (controller) to a set of clients (service engine). In various embodiments, object changes can be propagated in a push/pull model, meaning that configuration changes can be implemented in an API-like fashion that is also stateful, where the order of changes are followed. The techniques provide play forward (sometimes called fast forward) capabilities in which a client that has been disconnected can reconnect and “play forward” to apply each change in order to its own configuration state as well as play back to revert to an earlier state.

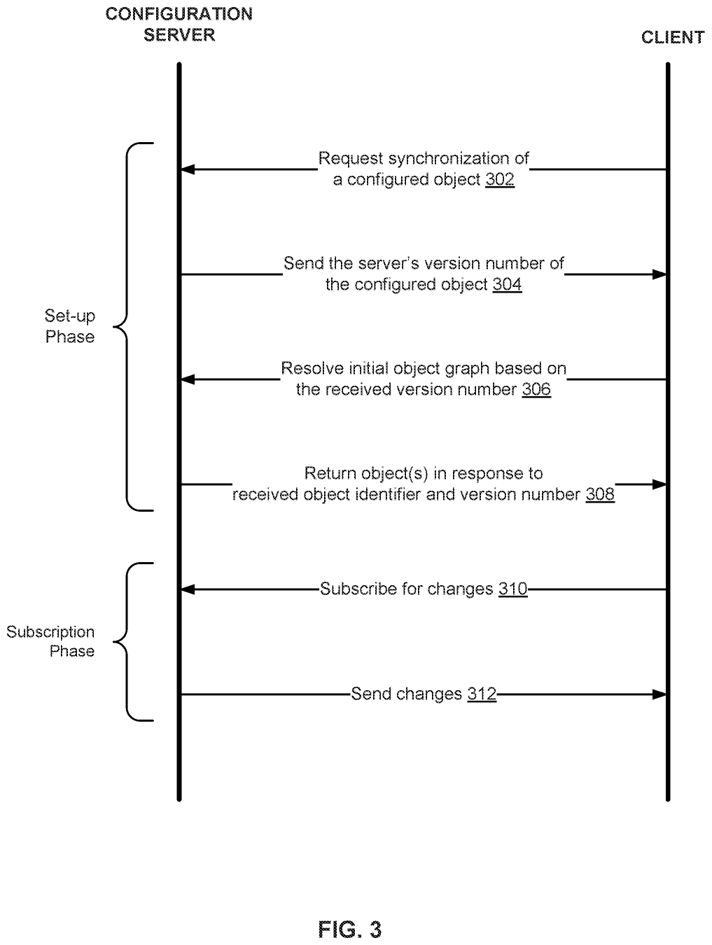

As further described with respect to FIG. 3, in various embodiments, a client-implemented process to propagate ordered object changes includes synchronizing the client's version of configured objects with a configuration server's version of configured objects. The synchronization includes obtaining a list of object identifiers and a first version identifier of an object from the configuration server. The client recursively gets objects at a version identified by the first version identifier from the configuration server to construct an object graph. The object graph constructed on the client is consistent with an object graph maintained on the configuration server. The client subscribes to a configuration stream associated with the configuration server, including sending the first version identifier as further described below. The configuration stream is a channel between a client and server that allows the server to send updates to the client. The client obtains a plurality of responses from the configuration server. For example, the responses can be streamed from the configuration server to the client so they are sometimes called “a stream of responses.” A response in the plurality of responses includes a second version identifier and a corresponding object identifier for an object that has been reconfigured between the first version and the second version. The client gets an updated version of the objects identified in the stream by the second version identifier to update the object graph. When the client has an object graph that matches the server's version of the object graph, then the client has received all of the configuration changes.

FIG. 8 shows an example of another application delivery platform with some different examples. The disclosed techniques can also be applied to the example shown FIG. 8.

The following figure shows a system for propagating ordered object changes. The number and assignment of tenant, service engines, server pools, health monitors and their names (UUIDs) are merely exemplary and not intended to be limiting.

FIG. 2 is a block diagram illustrating an embodiment of a system for propagating ordered object changes. The system may be part of an application delivery platform such as the one shown in FIG. 1. The system includes controller 210 and service engines (Service Engine 1 and Service Engine 2). The controller and service engines are like their counterparts in FIG. 1 unless otherwise described. The controller and service engines can be implemented by a programmed computer system such as the one shown in FIG. 7. The techniques for propagating ordered object changes can be implemented by configuration server 218 and client process 220.1 and 220.2 using diff queue 214 as described in greater detail below.

Controller 210 includes application programming interface (API) 212, diff queue 214, master state 216, and configuration server 218. The API can be RESTful, RPC, or the like.

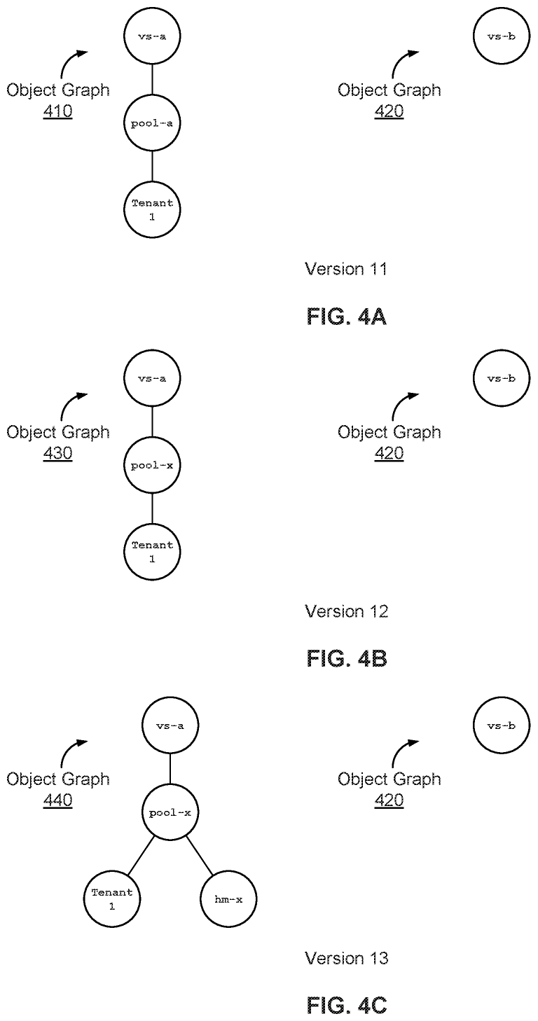

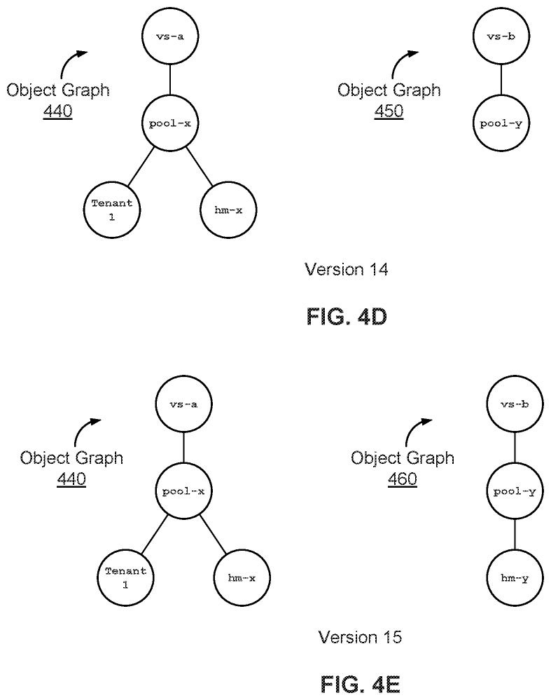

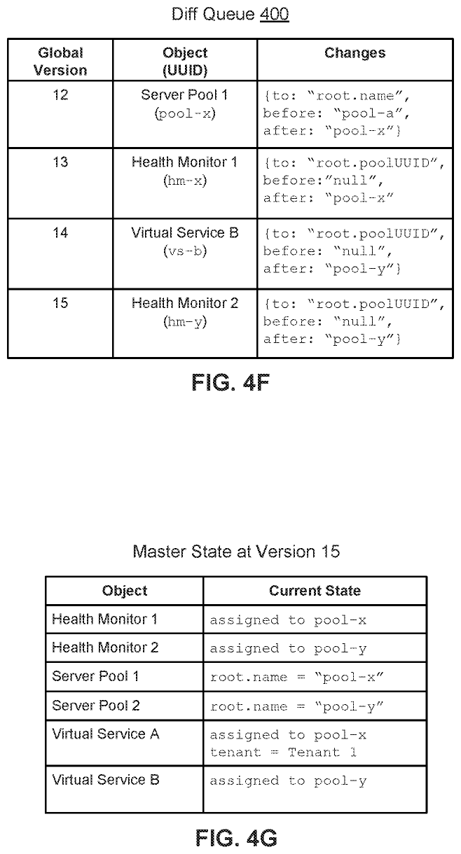

Master state 216 stores a current state of the system. When an API receives a configuration change, the master state is updated to reflect the state of the system after the change and the diff queue is updated to store the incremental change. Unlike the master state, which has only the current state of the system, the diff queue has a list of incremental changes, allowing play back and play forward of changes to reach a desired version of the system. The diff queue can be stored separately from the master state (as shown here), or alternatively the diff queue can be stored within a master state database. FIG. 4G shows an example of a master state.

Diff queue 214 is a persistent global queue of configuration changes that have occurred in the system. The diff queue is configured to store configuration changes (“diffs”) that have occurred in the system. The diff queue stores a version, an object changed (e.g., a pointer to or an identifier for an object to which the version applies), and changes applied to the object. The diff queue enables both forward and backward changes. The diff queue is atomically updated with configuration changes. For example, changes are stored in the diff queue by appending them to the diff queue.

The diff queue can be used to update an object to a specified version. Given an object at a particular version, the object can be updated to any later version. To update the object, a client queries the diff queue for the object's UUID and all interim changes. The client then applies the changes in order to the object.

The diff queue can be used to revert an object to an earlier version. Given an object at a particular version, the object can be reverted to any earlier version. To revert the object, a client queries the diff queue for the object's UUID and all interim changes. The client then applies the changes backwards to the object. The diff queue can be any combination of data structures such as a table, a set of tables, etc. FIG. 4F shows an example of a diff queue.

The configuration server 218 (sometimes simply called server) is configured to propagate changes stored in the diff queue to subscribers. The subscribers are client processes (sometimes simply called clients) running in the service engines. The server maintains an object store, an object graph, and a global version. On boot, the server loads all objects into its own internal object store and generate a graph representing the relationships between objects using the master state 216. In contrast to conventional systems (in which there is no diff queue and the server continues to communicate with the master state to obtain changes), after set up the server listens to (e.g., periodically polls) the diff queue, applying the diffs as they come in. The server looks in the diff queue for changes and propagates them to subscribers (the clients).

In various embodiments, the server maintains a global read/write lock so that when the server applies a diff, the server write locks the entire server store and graph and applies updates. This guarantees that whenever a reader read locks the server, the reader sees a consistent view of the configuration information. The server can provide a variety of RPC methods including “sync,” “get,” and “subscribe” to the client to propagate changes to the subscribers. Each of these RPC methods will be further described below. FIGS. 4A-4E show examples of a server's internal state (object graphs).

Each service engine includes a client 220.1 and 220.2. The client is an agent running on the service engine that takes a configuration change and applies it to the service engine. In various embodiments, the client uses an RPC service provided by the configuration server (e.g., calling “get,” “sync,” and “subscribe”) to retrieve objects. A service engine can be associated with a tenant that uses the service engine to provide services. Here Tenant 1 is associated with Service Engine 1. A server pool (such as Pool 1 or Pool 2) can be assigned to a service engine to provide computational resources to the service engine. A health monitor (Monitor 1 or Monitor 2) can be assigned to a server pool to monitor the health of the servers. The assignment of tenants, pools, and health monitors are examples of configurations, and the configuration (assignments) can change over time. For example, as demands from a service engine increase, additional servers can be added to its associated pool or a different pool can be assigned to the service engine.

Next, operation of this system will be described using example processes shown in the following figures.

FIG. 3 shows an example of a process to propagate ordered object changes. This figure shows the calls made by a client to a configuration server and the responses the server sends back to the client to help the client propagate configuration changes to objects associated with its service engine. An example of a client is client 220.1 or 220.2 and an example of server is server 218 shown in FIG. 2.

The first part of the process (302-308) can be thought of as a set-up phase, and the second part of the process (310-312) can be thought of as a subscription phase. In various embodiments, the set-up phase is performed under certain conditions such as on fresh start or when a client has been disconnected for more than a pre-defined time (e.g., 12 hours). The subscription phase is performed under certain conditions such as when the client has been disconnected for less than the pre-defined time. For example, on fresh start or a long disconnection, 302-312 is performed while only 310-312 are performed (skipping 302-308) if the client has experienced a short disconnection.

The client begins by requesting synchronization of a configured object (302). At this point, the client either does not have any configuration information about the object or knows that its information is obsolete. The synchronization request includes a request for a version number from the server. This version number is a first version number. Although called the first version, it is not necessarily global version number 1 and can be any version used to construct an initial object graph consistent with the server's object graph at that version. The initial object graph is a starting point to construct other object graphs.

The server responds by sending the server's version identifier (number) of the configured object (304). As described above, the server maintains an object store, an object graph, and a global version of the object. The client's request at 302 includes an object, so the server can look up a version associated with the object and send the version number. The server may also send identifiers of root level objects the client. A root level object is a top level object in an object graph such as an application representing a virtual service or a virtual service running on a service engine (the service engine being the object). The identifier can be a UUID.

Then, the client resolves an initial object graph based on the received version number (306). Resolving the initial object graph means that the client obtains information for a root level object and any children objects to construct an object graph consistent with the server's version. FIG. 4A shows an example of an object graph 410 where vs-a is a root level object with a child (pool-a) and a grandchild (Tenant 1). The client requests information for the root level object from the server and makes recursive calls (as necessary) for each of the children until the entire object graph is constructed. For example, the client requests a child object and the server sends the child object, then the client requests a grandchild object and the server sends the grandchild object, etc. until the entire object graph is resolved meaning there is a copy of object graph 410 at the client now as well.

When a client knows where an object belongs and has its configuration details, then the object is considered resolved. In some embodiments, the client may already have information about some of the objects. These objects are considered resolved and the client will not request information for the resolved objects to save on computational resources.

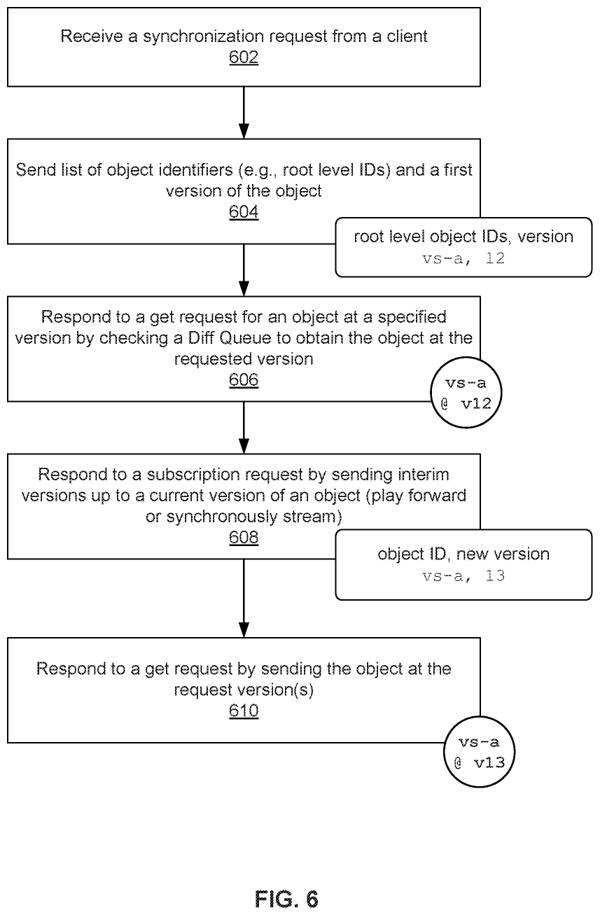

The server returns one or more objects in response to the received object identifier and version number (308). Referring to the same example above, when a client requests information for vs-a, the server sends vs-a. Then when the client requests pool-a, the server sends pool-a, etc. until all client requests have been serviced. In various embodiments, the server queries a diff queue to obtain the requested version of the object as further described in FIG. 6. Sometimes the server's current global version is more current than the requested version. The server plays back changes to get to the version desired by the client. For example, if a server is at global version 15 of an object but the client's request is for version 12. The server can get version 12 by playing back all changes between version 15 and version 12.

At the end of 308 (the set-up phase), the client has an object graph for an initial version and the object configurations at that version.

Sometimes while the server and client are performing the set-up phase, the system continues to be modified so that the global version is different from the version that the client has at the end of 308. In other words, objects are reconfigured between the client's version and a later version. To obtain interim changes, the client subscribes for changes (310). When the client subscribes to the server, the server will send changes to the client until the client is caught up to the latest version.

Some RPCs (such as gRPC) support streaming RPCs, which means that a client can request one object and receive many responses, request many objects and receive one response, or request many objects and receive many responses. Streaming RPCs can be thought of in one aspect as a bi-directional stream (also called a configuration stream) that keeps a channel open to allow a server to repeatedly send relevant updates to the client. So when a client sends an initial version number, the server can send back the initial version and interim versions until the current global version (312).

In some embodiments, the client gets caught up by receiving the interim version numbers from the server and resolving object graphs for the interim versions similar to 306-308. For example, at the end of 308, the client has an initial object graph for version 12. Meanwhile, the global version has updated to version 15. The server would send versions 13-15 to the client so that client knows the interim versions it missed. The client can the update its object graph to reflect changes in interim versions. In various embodiments, the client gets versions 13, 14, and 15 separately. First, the client receives version 13 (608), then calls get on version 13 (610). Next, the client receives version 14, then calls get on version 14. Finally, the client receives version 15, then calls get on version 15. FIG. 6 only shows the example for version 13, but steps 608 and 610 are repeated for versions 14 and 15. In some embodiments, the server automatically sends updated objects for the interim versions without needing the client to request the objects.

The following figures show examples of object graphs, diff queues, and states in the client and/or server, and are used to explain the process for propagating ordered object changes first from the point of view of the client and then from the point of view of the server.

FIG. 4A illustrates an example of a first version of an object graph. The object graph is a representation of objects in a system such as the application delivery network of FIG. 2 and can be represented by a tree as shown here. The object graph, which shows a state of a system before version 12, is consistent with the system of FIG. 2 and the diff queue of FIG. 4F. A server can construct an object graph and store it locally in 218. The relationships in the object graph represent configuration changes defined by a user. A client can construct an object graph consistent with the server's version using the techniques described here and store its version of the consistent object graph locally in 220.1 or 220.2. For example, at the end of 308 in FIG. 3, client 220.1 also has object graph 410.

Tree 410 represents the object graph for Service Engine 1 of FIG. 2 where the name of each object is its UUID (se-1 for Service Engine 1). The root level object is Virtual Service A (vs-a). The children of the root level object represents objects associated with or assigned to the root level object. Here the child of vs-a is a server pool (pool-a). The child of pool-a is Tenant 1 because the server pool is associated with Tenant 1 as shown in FIG. 2. At this point in time, pool-a does not have an assigned health monitor. When a health monitor gets assigned to pool-a, then the server's object graph changes to include the health monitor as a child as further explained below with respect to FIG. 4C.

Tree 420 represents the object graph for Service Engine 2 (se-2) of FIG. 2. At version 11, Service Engine 2 is not yet assigned to any tenant or pool, so the only object in its object graph is Virtual Service B (vs-b).

FIG. 4B illustrates an example of a version of an object graph after a pool has been renamed. This example corresponds to version 12 in diff queue 400 of FIG. 4F. At version 12, Server Pool 1 is renamed from pool-a to pool-x. As shown in object graph 430 of FIG. 4B, the child of vs-a now has the name pool-x.

FIG. 4C illustrates an example of a version of an object graph after a health monitor has been assigned to a server pool. This example corresponds to version 13 in diff queue 400 of FIG. 4F. At version 13, Health Monitor 1 (hm-x) is assigned to pool-x. As shown in object graph 440 of FIG. 4C, pool-x now has a new child hm-x to represent the relationship of assigning the health monitor to the pool.

FIG. 4D illustrates an example of a version of an object graph after a server pool has been assigned to a virtual service. This example corresponds to version 14 in diff queue 400 of FIG. 4F. At version 14, Server Pool 2 (pool-y) is assigned to Virtual Service B (vs-b). As shown in object graph 450 of FIG. 4D, vs-b now has a new child pool-y to represent the relationship of assigning the server pool to the virtual service.

FIG. 4E illustrates an example of a version of an object graph after a health monitor has been assigned to a second server pool. This example corresponds to version 15 in diff queue 400 of FIG. 4F. At version 15, Health Monitor 2 (hm-y) is assigned to pool-y. As shown in object graph 460 of FIG. 4E, the child of pool-y now has a new child hm-y to represent the relationship of assigning the health monitor to the pool.

FIG. 4F illustrates an example of a diff queue for propagating ordered changes. Referring to FIG. 2, diff queue 400 can be stored in master state storage 216 or stored separately as diff queue 214. The diff queue is maintained by server 218 to track configuration changes that have occurred in the system of FIG. 2. The example diff queue shown here is consistent with FIG. 2 and object graphs in FIGS. 4A-4E. As discussed above, the diff queue is described using the example of a database table, but any other suitable data structure can be used.

Each row represents a version, an object (identified by its UUID), and a set of changes. The changes include information to enable play back to an earlier version or play forward to a later version. The table here only shows a portion of the diff queue from versions 12 to 15 and omits version 12 and earlier for purposes of illustration. Referring to version 12, the configuration change is renaming Server Pool 1 to pool-x (where it was previously named pool-a). In this example, the change is to a pool object's name field (root.name), which takes a string. The name field (root.name) is changed from value “pool-a” to the value “pool-x.” These attributes are represented as shown, where “to” indicates the object's field that is changed, “before” indicates the previous value, and “after” indicates the current value. With this information, an object can be reverted to version 12, where the pool object's name is “pool-a” or played forward to version 12 where the pool object's name is “pool-x.”

The diff queue can be used to update an object to a specified version. Given an object at a particular version, the object can be updated to any later version. Suppose a client has version 12 of an object. The client can request version 15 and the server will look up and send all changes between version 12 and version 15. The client then applies the changes in order to the object.

The diff queue can be used to revert an object to an earlier version. Given an object at a particular version, the object can be reverted to any earlier version. Suppose a client requests an object at version 12 and the global version is now version 15. To revert the object, the server looks up all changes between version 15 and version 10, applies the changes backwards to the object, and sends version 12 to the client.

The size of the diff queue can be managed to optimally use available storage or to reduce space used to store the diff queue. In some embodiments, a configuration server cleans the queue automatically to only have a most recent pre-determined number of configuration changes such as a pre-defined number of the most recent configuration changes needed by any client (including disconnected ones). For example, those configuration changes falling within a pre-defined time period (such as 12 hours or 24 hours) are retained in the queue and older configuration changes are discarded. As another example, in a three-node controller, the most recent 1 million changes are retained while older ones are discarded.

In some embodiments, a client that disconnects for a relatively short time is able to reconnect and play forward using the diff queue while a client that is disconnected for a relatively longer time (e.g., 24 hours) resyncs by starting afresh. The size of the diff queue can be determined based on conditions in which clients should re-sync vs use play forward. For example, a larger diff queue uses more storage but would allow a client that disconnects for a relatively longer time to reconnect and play forward using the diff queue instead of using a fresh start procedure.

FIG. 4G illustrates an example of a master state for propagating ordered changes. The master state can be stored in master state storage 216. The master state here is consistent with FIGS. 4E and 4F and FIG. 2 and shows the master state at version 15. The state of an object is listed alongside the object. For example, Health Monitor 1 is assigned to pool-x and named hm-x. Although shown as a table in this example, any suitable data structure can be used to store the master state.

The following figure shows an example process for propagating ordered object change from the point of view of the client in greater detail.

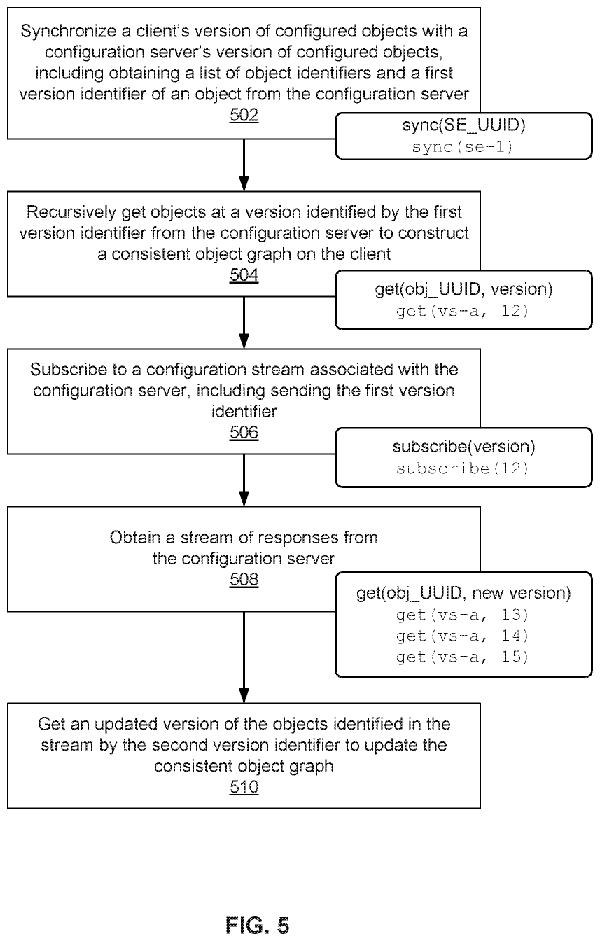

FIG. 5 is a flow chart illustrating an embodiment of a process performed by a client to propagate ordered object changes. The flow chart shows an example gRPC call next to each step, but this is not intended to be limiting and other protocols may be used instead. The process shown here will be explained with the aid of FIGS. 2 and 4A-4F. The process may be implemented by a client such as 220.1 and 220.2 of FIG. 2.

The process begins by synchronizing the client's version of configured objects with a configuration server's version of configured objects, including obtaining a list of object identifiers and a first version identifier of an object from the configuration server (502). The version identifier (number) may follow a linear incrementing system. Referring to FIG. 2, suppose Service Engine 1 wants to obtain configuration changes from configuration server 218. Client 220.1 would call “sync” with the client's UUID, which is se-1 as shown in the example call at 502 of FIG. 5. When server 218 receives this call, it sends back a list of object identifiers (root level object IDs) and the most current global version of the system. Suppose for this example that at the time of the client's sync request, the most current global version is version 12.

The list of root level object IDs is the list of the object identifiers and the version number maintained by the server is the first version identifier of the object obtained at 502. The “first version” is not necessarily a global version 1 but instead is used to distinguish from a different version, which is called a “second version.” For this example, the first version is global version 12 and the second version is global version 15. Referring to FIG. 4B at version 12, a root-level ID for se-1 is vs-a (Virtual Service A) and the version number maintained by the server is global version 12.

Client 220.1 now has a list of one or more root level objects and a version number. The client can proceed to make an object graph by calling the server with a root level object ID and the version number. If the root level object has children, the client can call the server with the children and version number as follows.

The process recursively gets objects at a version identified by the first version identifier from the configuration server to construct a consistent object graph on the client (504). The client gets an object by copying configuration information about an object from the server. When the client calls the server with a root level object ID and a version number, the server will send a state of the object at the requested version allowing the client to construct an object graph that is consistent with the server's version of the object graph. Since the client has the root level object ID, it can determine children of the root object and get information about the children, grandchildren, etc. of the root object. Referring to FIG. 4B, a client that does not previously have information about the object graph for se-1 can now construct graph 410 by getting object vs-a, then getting object pool-x, and finally getting object tenant-1. Client 220.1 would call “get” with the object UUID (vs-a) and a desired version (12) as shown in the example call at 504 of FIG. 5. Then, the client would call “get” with the object UUID (pool-x) and a desired version (12). Next, the client would call “get” with the object UUID (Tenant 1) and a desired version (12).

In some embodiments, the client already has information about some objects. These objects are called resolved objects. In this situation, a client can recursively call get only on unresolved objects to save on computational resources. Suppose Tenant 1 is already resolved, then the client would not call get for the tenant.

At the end of 504, the client has a consistent object graph of the service engine at a specific version. The object graph is consistent with the server's version. Sometimes, during the time the client was constructing the consistent object graph, further configuration changes are made to the system so that the system is now at a later global version. The client can catch up to the current global version by subscribing to a server as follows.

The process subscribes to a configuration stream associated with the configuration server, including sending the first version identifier (506). Suppose at the end of 504, client 220.1 has object graph 430 (version 12) and the global version is now at version 15 (see FIG. 4E). As explained above, some RPCs support a bi-directional stream (also called a configuration stream) that allows a server to repeatedly sent updates to a client. The client can subscribe to the configuration stream to catch up to a current global version. Client 220.1 would call “subscribe” with the client's current version (12) as shown in the example call at 506 of FIG. 5.

The process obtains a stream of responses from the configuration server, where a response in the stream of responses includes: a second version identifier and a corresponding object identifier for an object that has been reconfigured between the first version and the second version (508). The server sends an object ID and version number for interim versions between the client's current version and the global version. Suppose the global version is now 15, then the server would send versions 13 to 15. Between version 12 and version 15, pool-x is reconfigured because hm-x is assigned to the pool.

The process gets an updated version of the objects identified in the stream by the second version identifier to update the consistent object graph (510). Client 220.1 would call “get” with the client's current version (12) and then with the next version until all interim versions have been called and as shown in the example calls at 508 of FIG. 5. When the client calls the server with an object identifier and a version number, the server will send a state of the object at the requested version allowing the client to construct an object graph. As explained with respect to 504, the client may recursively get objects (a root level object, then a child, a grandchild, etc.) to construct an object graph consistent with a server's version.

In some embodiments, the client does not need to call “get” with the interim versions. Instead the server will automatically send the objects at 506 so that the process proceeds directly from 506 to 510. This may improve the efficiency of the process because the client automatically receives objects without needing to actively request them from the server.

The following figure describes a process for propagating ordered object changes from the point of view of the server in greater detail.

FIG. 6 is a flow chart illustrating an embodiment of a process performed by a server to propagate ordered object changes. The flow chart shows an example response to a gRPC call next to each step, but this is not intended to be limiting and other RPC protocols may be used instead. The process shown here will be explained with the aid of FIGS. 2 and 4A-4F and using the same example as FIG. 5. The process may be implemented by a configuration server such as 218 of FIG. 2.

The process begins by receiving a synchronization request from a client (602). The synchronization request includes the client's UUID, which is se-1 in this example (see 502). The server determines a version number and list of root level object identifiers to send back to the client. The version number is the server's most current global version. For this example suppose that at the time the client sends the synchronization request the most current global version is version 12. The server maintains object graphs for each client. Here, the server looks up the object graphs for client se-1 at version 12, which is tree 430 of FIG. 4B. In this example there is only one root level object, which is Virtual Service A (UUID is vs-a).

The configuration server sends a list of object identifiers such as root level identifiers and a first version identifier of the object (604). In response to the synchronization request, the server sends the version (called the first version to differentiate from later versions that the server might send to the client) and the root level object identifiers to the client which is version 12 and vs-a as shown next to 604.

The configuration server responds to a get request for an object at a specified version by checking a diff queue to obtain the object at the requested version (606). As described above, the client may send get requests in an effort to construct an object graph consistent with the server's version of the object graph. The client sends get requests accompanied by an object ID and version number. The server finds the appropriate object at the requested version to return to the client. To do so, the server checks a diff queue such as diff queue 400 of FIG. 4F to look up the requested version. If the requested version is the most current global version, then the server simply returns the object (represented by vs-a @ v12) at 606 in FIG. 6.

Sometimes the client's requested version is not the latest version (because additional configuration changes may have come in). If so, the server can play back to the requested version by reverting changes between a current global version and the requested version in order to get the object to the state at the requested version to send to the client.

In various embodiments, the client sends multiple get requests (recursively calls get) to the configuration server to build the object graph starting from the root node and traversing through the tree until all unresolved objects have been resolved. For tree 430, client may call get on se-1, then vs-a, then pool-x, and finally tenant-1. The representation is not shown in FIG. 6 so as not to clutter the illustration but would look like pool-x @ v12 and Tenant 1 @ v12. As discussed above, the client may already have information about some objects. These objects are considered resolved and the client does not call get on the resolved objects. At the end of 606, the server has sent all the information needed for the client to construct an object graph of the service engine consistent with the server's version of the object graph.

Sometimes, after the time the client sent the synchronization request (602) additional configuration changes are made so that the global version has advanced to a later version (version 15 for example). To catch up to the current global version, the client sends a subscription request to the server. The subscription request includes the client's current version (for example version 12). Thus the client wants to catch up from version 12 to the current global version which is version 15.

The configuration server responds to a subscription request by sending interim versions up to a current version of an object (608). The server determines all interim versions between the client's version (in the subscription request) and the current global version by looking in the diff queue. Here, the interim versions are versions 13-15. The server sends each of these versions with root level object IDs as shown.

The configuration server responds to a get request by sending the object at the requested version(s) (610). As described above, the client may send get requests in an effort to construct an object graph consistent with the server's version of the object graph. The get requests may be for a root level object and children objects. In some embodiments, requests are made only for those objects that are unresolved and not for those that are already resolved. In response, the server finds the appropriate object at the requested version to return to the client as shown.

The techniques for propagating ordered object changes disclosed here may also have a number of security features. For example, when responding to a get request (606 or 610) or subscription request (608), the configuration server checks the client's permission for that specific version. The configuration server checks the permission in the latest version by traversing the graph to the relevant security object. For example, the configuration server traverses to the tenant object and then compares that tenant to the tenant of the service engine to determine if the service engine has access to that object. This allows clients to only access object at a specific version for which the client has access and not other versions. Put another way, this prevents a client who has permission to access an object at a different version but not at the requested version from improperly access the requested versions of the object or any other version different from the permitted version.

FIG. 7 is a functional diagram illustrating a programmed computer system for propagating ordered object changes in accordance with some embodiments. As will be apparent, other computer system architectures and configurations can be used to propagate ordered object changes. Computer system 100, which includes various subsystems as described below, includes at least one microprocessor subsystem (also referred to as a processor or a central processing unit (CPU)) 102. For example, processor 102 can be implemented by a single-chip processor or by multiple processors. In some embodiments, processor 102 is a general purpose digital processor that controls the operation of the computer system 100. Using instructions retrieved from memory 110, the processor 102 controls the reception and manipulation of input data, and the output and display of data on output devices (e.g., display 118). In some embodiments, processor 102 includes and/or is used to provide client 220.1 and 220.2 or configuration server 218 of FIG. 2.

Processor 102 is coupled bi-directionally with memory 110, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 102. Also as is well known in the art, primary storage typically includes basic operating instructions, program code, data and objects used by the processor 102 to perform its functions (e.g., programmed instructions). For example, memory 110 can include any suitable computer-readable storage media, described below, depending on whether, for example, data access needs to be bi-directional or uni-directional. For example, processor 102 can also directly and very rapidly retrieve and store frequently needed data in a cache memory (not shown).

A removable mass storage device 112 provides additional data storage capacity for the computer system 100, and is coupled either bi-directionally (read/write) or uni-directionally (read only) to processor 102. For example, storage 112 can also include computer-readable media such as magnetic tape, flash memory, PC-CARDS, portable mass storage devices, holographic storage devices, and other storage devices. A fixed mass storage 120 can also, for example, provide additional data storage capacity. The most common example of mass storage 120 is a hard disk drive. Mass storage 112, 120 generally store additional programming instructions, data, and the like that typically are not in active use by the processor 102. It will be appreciated that the information retained within mass storage 112 and 120 can be incorporated, if needed, in standard fashion as part of memory 110 (e.g., RAM) as virtual memory.

In addition to providing processor 102 access to storage subsystems, bus 114 can also be used to provide access to other subsystems and devices. As shown, these can include a display monitor 118, a network interface 116, a keyboard 104, and a pointing device 106, as well as an auxiliary input/output device interface, a sound card, speakers, and other subsystems as needed. For example, the pointing device 106 can be a mouse, stylus, track ball, or tablet, and is useful for interacting with a graphical user interface.

The network interface 116 allows processor 102 to be coupled to another computer, computer network, or telecommunications network using a network connection as shown. For example, through the network interface 116, the processor 102 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 102 can be used to connect the computer system 100 to an external network and transfer data according to standard protocols. For example, various process embodiments disclosed herein can be executed on processor 102, or can be performed across a network such as the Internet, intranet networks, or local area networks, in conjunction with a remote processor that shares a portion of the processing. Additional mass storage devices (not shown) can also be connected to processor 102 through network interface 116.

An auxiliary I/O device interface (not shown) can be used in conjunction with computer system 100. The auxiliary I/O device interface can include general and customized interfaces that allow the processor 102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

FIG. 8 is a block diagram illustrating an embodiment of a distributed network service platform. In this example, the platform includes a number of servers configured to provide a distributed network service. A physical server (e.g., 802, 804, 806, etc.) has hardware components and software components. In particular, hardware (e.g., 808) of the server supports operating system software in which a number of virtual machines (VMs) (e.g., 818, 819, etc.) are configured to execute. A VM is a software implementation of a machine (e.g., a computer) that simulates the way a physical machine executes programs. The part of the server's operation system that manages the VMs is referred to as the hypervisor. The hypervisor interfaces between the physical hardware and the VMs, providing a layer of abstraction to the VMs. Through its management of the VMs' sharing of the physical hardware resources, the hypervisor makes it appear as though each VM were running on its own dedicated hardware. Examples of hypervisors include the VMware Workstation® and Oracle VM VirtualBox®.

In some embodiments, instances of network applications are configured to execute within the VMs. Examples of such network applications include web applications such as shopping cart, user authentication, credit card authentication, email, file sharing, virtual desktops, voice/video streaming, online collaboration, etc. A distributed network service layer is formed to provide multiple application instances executing on different physical devices with network services. As used herein, network services refer to services that pertain to network functions, such as load balancing, authorization, security, content acceleration, analytics, application management, etc. As used herein, an application that is serviced by the distributed network service is referred to as a target application. Multiple instances of an application (e.g., multiple processes) can be launched on multiple VMs.

Inside the hypervisor there are multiple modules providing different functionalities. One of the modules is a virtual switch (e.g., 812, 822, etc.). A physical hardware has one or more physical ports (e.g., Ethernet ports). Network traffic (e.g., data packets) can be transmitted or received by any of the physical ports, to or from any VMs. The virtual switch is configured to direct traffic to and from one or more appropriate VMs, such as the VM in which the service engine on the device is operating.

One or more service engines (e.g., 814) are instantiated on a physical device. In some embodiments, a service engine is implemented as software executing in a virtual machine. The service engine is executed to provide distributed network services for applications executing on the same physical server as the service engine, and/or for applications executing on different physical servers. In some embodiments, the service engine is configured to enable appropriate service components that implement service logic. For example, a load balancer component is executed to provide load balancing logic to distribute traffic load amongst instances of target applications executing on the local physical device as well as other physical devices; a firewall component is executed to provide firewall logic to instances of the target applications on various devices. Many other service components may be implemented and enabled as appropriate. When a specific service is desired, a corresponding service component is configured and invoked by the service engine to execute in a VM.

In some embodiments, the performance of the target applications is monitored by the service engines, which are in turn monitored by controller 890. In some embodiments, all service engines maintain their own copy of current performance status of the target applications. A dedicated monitoring service engine is selected to send heartbeat signals (e.g., packets or other data of predefined format) to the target applications and update the performance status to other service engines as needed. For example, if a heartbeat is not acknowledged by a particular target application instance within a predefined amount of time, the monitoring service engine will mark the target application instance as having failed, and disseminate the information to other service engines. In some embodiments, controller 890 collects performance information from the service engines, analyzes the performance information, and sends data to client applications for display.

A virtual switch such as 812 interacts with the service engines, and uses existing networking Application Programming Interfaces (APIs) (such as APIs provided by the operating system) to direct traffic and provide distributed network services for target applications deployed on the network. The operating system and the target applications implement the API calls (e.g., API calls to send data to or receive data from a specific socket at an Internet Protocol (IP) address). In some embodiments, the virtual switch is configured to be in-line with one or more VMs and intercepts traffic designated to and from instances of the target applications executing on the VMs. When a networking API call is invoked, traffic is intercepted by the in-line virtual switch, which directs the traffic to or from the appropriate VM on which instances of the target application executes. In some embodiments, a service engine sends data to and receives data from a target application via the virtual switch.

A controller 890 is configured to control, monitor, program, and/or provision the distributed network services and virtual machines. In particular, the controller is configured to control, monitor, program, and/or provision a group of service engines, and is configured to perform functions such as bringing up the service engines, downloading software onto the service engines, sending configuration information to the service engines, monitoring the service engines' operations, detecting and handling failures, and/or collecting analytics information. The controller can be implemented as software, hardware, firmware, or any combination thereof. In some embodiments, the controller is deployed within the VM of a physical device or other appropriate environment. In some embodiments, the controller interacts with client applications to provide information needed by the user interface to present data to the end user, and with a virtualization infrastructure management application to configure VMs and obtain VM-related data. In some embodiments, the controller is implemented as a single entity logically, but multiple instances of the controller are installed and executed on multiple physical devices to provide high availability and increased capacity. In some embodiments, known techniques such as those used in distributed databases are applied to synchronize and maintain coherency of data among the controller instances.

In the example shown, the service engines cooperate to function as a single entity, forming a distributed network service layer 856 to provide services to the target applications. In other words, although multiple service engines (e.g., 814, 824, etc.) are installed and running on multiple physical servers, they cooperate to act as a single layer 856 across these physical devices. In some embodiments, the service engines cooperate by sharing states or other data structures. In other words, copies of the states or other global data are maintained and synchronized for the service engines and the controller.

In some embodiments, a single service layer is presented to the target applications to provide the target applications with services. The interaction between the target applications and service layer is transparent in some cases. For example, if a load balancing service is provided by the service layer, the target application sends and receives data via existing APIs as it would with a standard, non-distributed load balancing device. In some embodiments, the target applications are modified to take advantage of the services provided by the service layer. For example, if a compression service is provided by the service layer, the target application can be reconfigured to omit compression operations.

From a target application's point of view, a single service layer object is instantiated. The target application communicates with the single service layer object, even though in some implementations multiple service engine objects are replicated and executed on multiple servers.

Traffic received on a physical port of a server (e.g., a communications interface such as Ethernet port 815) is sent to the virtual switch (e.g., 812). In some embodiments, the virtual switch is configured to use an API provided by the hypervisor to intercept incoming traffic designated for the target application(s) in an in-line mode, and send the traffic to an appropriate service engine. In in-line mode, packets are forwarded on without being replicated. As shown, the virtual switch passes the traffic to a service engine in the distributed network service layer (e.g., the service engine on the same physical device), which transforms the packets if needed and redirects the packets to the appropriate target application. The service engine, based on factors such as configured rules and operating conditions, redirects the traffic to an appropriate target application executing in a VM on a server.

The disclosed techniques for propagating ordered object changes reduces or eliminates many of the disadvantages of typical systems by streaming object changes. Consequently, the functioning of a computer and network is improved. In addition, the technical field of application delivery is improved because requests can be more efficiently serviced. Unlike a conventional system that receives a configuration changes via an API and notifies an RPC to add the change to a set of changes to be later distributed to service engines, the techniques described here more efficiently propagate ordered changes to clients by streaming configuration changes to clients.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
synchronizing, by a client, the client's version of configured objects with a configuration server's version of configured objects, including obtaining a list of object identifiers and a first version identifier of an object from the configuration server;
recursively getting objects at a version identified by the first version identifier from the configuration server to construct an object graph on the client;
subscribing to a configuration stream associated with the configuration server, including sending the first version identifier;
obtaining a plurality of responses from the configuration server, wherein a response in the plurality of responses includes: a second version identifier and a corresponding object identifier for an object that has been reconfigured between the first version and the second version; and
getting an updated version of the objects identified in the stream by the second version identifier to update the object graph.

2. The method of claim 1, wherein the object graph constructed on the client is consistent with an object graph maintained on the configuration server.

3. The method of claim 1, wherein a diff queue comprising a log of configuration changes is maintained on the configuration server and the diff queue is atomically updated with configuration changes.

4. The method of claim 1, wherein an object store of objects to be configured on the client is maintained by the configuration server.

5. The method of claim 1, wherein the client is configured to make remote procedure calls to get an object at a specified version.

6. The method of claim 1, wherein the client is configured to make remote procedure calls to subscribe to the configuration stream to automatically get a plurality of configuration changes.

7. The method of claim 1, wherein recursively getting objects includes recursively getting a child object.

8. The method of claim 1, wherein the plurality of responses and the updated version of the objects are automatically obtained in response to subscribing to the configuration stream.

9. The method of claim 1, wherein the object graph of the client is at a same version as at least one object graph maintained by the configuration server.

10. The method of claim 1, wherein a version of an object is identified by a version identifier following a linear incrementing system.

11. The method of claim 1, wherein getting an updated version of the objects includes determining those objects in an object graph that are unresolved and calling the configuration server for the unresolved objects.

12. The method of claim 1, wherein the client is stateful and follows an order that configuration changes are made.

13. The method of claim 1, further comprising determining that the client has been disconnected from the server for longer than a threshold time and synchronizing the client's version of configured objects and recursively getting objects at the version identified by the first version identifier in response to the determination that the client has been disconnected from the server for longer than the threshold time.

14. A system comprising:
a processor configured to:
synchronize a client's version of configured objects with a configuration server's version of configured objects, including obtaining a list of object identifiers and a first version identifier of an object from the configuration server;
recursively get objects at a version identified by the first version identifier from the configuration server to construct an object graph on the client;
subscribe to a configuration stream associated with the configuration server, including sending the first version identifier;
obtain a plurality of responses from the configuration server, wherein a response in the plurality of responses includes: a second version identifier and a corresponding object identifier for an object that has been reconfigured between the first version and the second version; and
get an updated version of the objects identified in the stream by the second version identifier to update the object graph; and
a memory coupled to the processor and configured to provide the processor with instructions.

15. A computer program product embodied in a non-transitory computer readable storage medium and comprising computer instructions for:
synchronizing a client's version of configured objects with a configuration server's version of configured objects, including obtaining a list of object identifiers and a first version identifier of an object from the configuration server;
recursively getting objects at a version identified by the first version identifier from the configuration server to construct an object graph on the client;
subscribing to a configuration stream associated with the configuration server, including sending the first version identifier;
obtaining a plurality of responses from the configuration server, wherein a response in the plurality of responses includes: a second version identifier and a corresponding object identifier for an object that has been reconfigured between the first version and the second version; and
getting an updated version of the objects identified in the stream by the second version identifier to update the object graph.

16. A method comprising:
in response to a synchronization request from a client, sending by a configuration server a list of object identifiers and a first version identifier of an object;
in response to a request from the client, checking by the configuration server a diff queue to obtain an object at a requested version; and
in response to a subscription request, sending by the configuration server at least one interim version for an object that has been reconfigured between a version identified with the subscription request and a current global version.

17. The method of claim 15, further comprising atomically updating by the configuration server the diff queue with configuration changes.

18. The method of claim 16, wherein the configuration changes include settings of objects in an application delivery platform specified by an administrator.

19. The method of claim 15, further comprising managing a size of the diff queue based on at least one of: available storage, a time threshold, and expected requests from clients including at least one disconnected client.

20. The method of claim 15, further comprising determining the client's permission to access a requested version by checking the client's permission to access an object at the requested version.

21. The method of claim 15, wherein the configuration server is stateful and follows an order that configuration changes are made.
